(19) United States
(12) Patent Application Publication
(10) Pub. No.: US 2016/0054649 A1
(43) Pub. Date: Feb. 25, 2016

(54) Device and Method to process media, in particular paper, film, leather, or fabric

(71) Applicant: Wolfgang Balga, Starnberg (DE)

(72) Inventor: Wolfgang Balga, Starnberg (DE)

(21) Appl. No.: 14/509,581

(22) Filed: Oct. 8, 2014

(30) Foreign Application Priority Data
Aug. 19, 2014 (DE) DE102014111807.3

(51) Int. Cl. G03C 11/06; G01N 27/00; H05B 6/62

(52) U.S. Cl. CPC G03C 11/06; H05B 6/62; G01N 27/00

(57) ABSTRACT

The invention concerns a device (2) for processing a medium (10), in particular for long-term storage and/or archiving the medium (10). The device comprises a sensor (62) for detecting a humidity value of the medium (10) and/or a medium-holder (4), a heating element (60), in order to dielectrically heat the medium (10) and/or the medium-holder (4), and a control element built such that it determines a heating power based on the detected humidity value, which is to be applied to the medium (10) and/or the medium-holder (4), in order to set the humidity of the medium (10) to a predetermined value. Further, the invention relates to a method for the corresponding processing of the medium (10) or the medium-holder (4).

This application claims the benefit of German Patent Application No. DE 10 2014 111 807.3, filed Aug. 19, 2014, the entirety of which is hereby incorporated herein by reference.

### BACKGROUND OF THE INVENTION

1. Field of the Invention

The present invention concerns a device and a method to process media, in particular film, paper, leather, or fabric.

2. Description of the Related Art

For media, which are permanently stored, for instance media having an information carrier layer, damage or destruction of the medium may occur in multiple ways in the course of time. As an example, mold, mildew, mildew spots, or other damages caused by humidity may occur.

Besides humidity and nutrients, further factors are relevant for the destruction of the carrier material and thus for the loss of information on the carrier.

Cellulose acetate, which is commonly used as carrier material, also has its part therein. Cellulose acetate was used from 1930 until the beginnings of the nineties of the last century in photography and filming worldwide. This material is now stored to a big extent in archives.

Such a cellulose acetate material has the big disadvantage that in the course of time, in an interaction of temperature and humidity, the cellulose acetate dissolves into its components in a hydrolytic decomposition (hydrolysis=fission of a chemical compound due to reaction with water) and frees up acetic acid. This phenomenon, which can occur during permanent storage, is denoted as the so called vinegar-syndrome in film material. The acetic acid which is thus generated gradually migrates to the surface of the film and that way releases the typical smell of vinegar. In connection with the invention, the terms film or film material, etc, are substitutions also for photographic film and other carrier materials, which comprise cellulose acetate.

The hydrolytic separation is always present, but is primarily influenced by temperature and humidity. The reaction often is lengthy. However, the more acid is released, the faster this chain reaction, also referred to as auto-catalytic reaction, may proceed. The acid being released also accelerates the reaction and can also infect other films, such as other films stored in an archive. For that reason, affected films or carrier materials should be separated from other material.

At times, a deposition can be observed on the film surface of a film affected by the vinegar syndrome. This is a softener (triphenyl phosphate), which crystallizes on the surface. Due to the loss of the softener and due to the separation of the acetate groups, the film becomes fragile and shrinks. In very advanced stages of the vinegar syndrome, the film can decrease size up to 10%. This may lead to uselessness of the film.

A further problem further is the difference in velocity of decomposition of the film basis and the gelatin disposed on the film. Since the basis decays faster than the gelatin, the gelatin layer separates from the basis. The gelatin itself is barely attacked by the acetic acid. However, colors may bleach.

The reaction velocity of the hydrolytic decomposition is further influenced by metal ions. Thus, also magnetic audio tracks can be amplifying for this effect. The vinegar syndrome can neither be stopped nor reversed.

One way to reduce or to delay this effect requires storage of the medium as optimal as possible. Optimal storage conditions are mainly dependent on the temperature and the humidity.

For storage, the temperature and the relative humidity should be constant at intermediate values. Preferably, a surveillance of the values by means of suitable measurement equipment should take place around the clock. Therein, the relative humidity should not exceed of 55%, lower values would be ideal.

Further, it is common in archives to store media with cellulose acetate after the drying at about 4° C. Known methods for drying are for instance air drying or the storage in ventilated and cooled storage rooms. In archives, these are in fact the only established methods used.

Effects of vacuum methods and methods using microwave application on the material thus far are not investigated. One such method is for instance described in document DE 603 19 061 T2. These methods, however, are by all means elaborate and only allow little control of the humidity, which remains in the medium to be dried. An economic use of these methods with the known procedures is not practical in big scales due to the high expenditure of time.

It is the object of the invention, to provide an apparatus and a method, which allow an improved processing for photography or film material and a better storage durability of the stored materials.

This object is solved with a device and a method according to the independent claims. Advantages developments are subject to the dependent claims.

### SUMMARY OF THE INVENTION

A device for storing a medium according to the present invention comprises a sensor for detecting a value of humidity of the medium. This sensor or a further sensor can also be built such that a humidity value can be determined, which is provided in a holder of the medium or in the room this holder comprises. Further, according to the invention, a heat source may for instance be provided as a heating element designed to dielectrically heat the medium. A control element is built to determine a heating power, which is to be applied to the medium and/or the medium-holder, based on the detected humidity value, in order to set the humidity of the medium to a predetermined value.

That way, an exact setting of the humidity of the medium can be performed. This may delay the occurrence of the vinegar syndrome, when appropriately stored in an air-tight way.

The heat source may in some embodiments of the invention be a microwave emitter. In contrast to convective heating, such as in compartment dryers, where heat energy is conducted to a probe from outside by way of convection, radiation or conduction and is distributed within the probe due to its heat conductivity, during dielectric heating the heat is generated inside the good itself. During microwave drying, the polar water molecules of the cellulose acetate carrier are exposed to a focused microwave field, which in turn leads to heat development in the inside of the material due to intermolecular friction of the water molecules (dipole rotation and ion conduction). Since no loss of heat conductivity occurs, the energy required for drying may be significantly reduced, such that there is no risk for the good.

That way, the time for drying of a common 35 mm cellulose acetate film roll may be decreased from originally one working day with conventional methods to about 2 minutes. That way, an economic processing of archived film rolls can be allowed.

The microwave emitter can be built such that the radiation energy is adjusted to the material to be dried, here in particular cellulose acetate.

Preferably, the invention uses a microwave frequency of 2450 MHz, which is approved by the Authority for International Communication. Water molecules change between an ordered and disordered state as a consequence of the oscillating and pulsating electric field. This causes a rotation excitation of dipoles and a molecular movement due to the migration of the ions and that way leads to a tremendously quick heating of the good due to intermolecular friction. The exposure time and the amount of energy depend on the humidity present in the good. The device according to the invention thus is capable to reduce a relative humidity of 4% in, e.g., a 35 mm cellulose acetate film roll with a mass of 1 kg within 2 minutes to a relative humidity of 2.6%, without the good heating to more than body temperature.

The device may further comprise a sensor, which is built to detect a pH-value and/or a content of acetic acid of the medium and/or the medium-holder. That way, it can be determined, whether the vinegar syndrome has already occurred. Thus, by separating the affected film material, it can be prevented, that the vinegar syndrome spreads further.

The control element can further comprise a storage, which is built to store the detected humidity value and/or the detected pH-value and/or the content of acetic acid. With this, a value can be recorded in the beginning of a processing or storage of the material. This value may be compared with actual values in the course of the processing. Further, based on the detected or stored value, processing parameters such as processing time and similar may be determined. For this, as an example, an algorithm may be provided in the control element, which calculates an amount of energy, which has to be provided to the medium, in order for the medium to have a predetermined, desired remaining humidity value.

Further, in some embodiments, the device may comprise means to neutralize acid. This allows withdrawing humidity from the medium and reducing of the acid content, in particular a content of acetic acid, in one process. That way, a processing time may be reduced and efficiency for processing the medium may be increased. This may also allow that media, which were already stored and being affected by the vinegar syndrome, may be processed and restored with improved storage conditions, without manual intermediate steps being necessary between the removal or neutralization of acid and the drying of the medium.

The means for neutralization of the acid in particular can be built such that it can hold an alkaline solution, in particular natron-water base, and apply it on and/or in the medium. That way, a systematic processing of affected media can be conducted. In particular, that way also a processing of individual regions of an affected film material can be conducted. Therefore, merely the respective sensors have to have a sufficient resolution power. This may in turn reduce the processing time for neutralizing the acid.

For neutralization preferably an aqueous solution of a natron base (caustic soda) with a pH-value of 8.33 is used. This is more alkaline than vinegar, which is acidic having a pH-value of 2.87. That way, natron base and acetic acid convert to sodium acetate and water according to the reaction equation:

CH₃COOH+NaOH→CH₃OONa+H₂O.

In some embodiments, the device may further comprise a fan, which is built to cause an air movement above the medium. That way, for instance during heating of the medium by means of the heat source, the air enriched with the released humidity can be transported away. In the device thus a discharged air system can be provided, through which air can be delivered to a processing space. A processing space is the space, in which the medium is stored during the processing.

In some embodiments, the medium can in particular be a film, video, and/or audio material. In particular, the medium can be a film roll or a photographic film. The present invention thus allows a processing of film rolls, which are to be archived, or a processing of film rolls which already are archived. The vinegar syndrome can be delayed or reduced by drying the film rolls and neutralizing the acetic acid, which may possibly be present thereon.

In a particular embodiment of the invention, a device is provided, which only comprises the means for detecting and neutralizing a pH-value or a content of vinegar in a medium, independent of a heating source for drying the medium.

Another aspect of the invention concerns a method for archiving a medium with a method step, in which the humidity of the medium is detected by means of a sensor. In another step, the heating power to be applied in order to set the humidity of the medium to a predetermined value is determined. The heating power thus determined is emitted by means of a heat emitter. That way, the humidity content of the medium can be set to a predetermined, optimal value. That way, an occurrence of the vinegar syndrome can be delayed, without damaging the medium due to low humidity value or during the storage.

Subsequently or prior thereto, the medium can be transferred into a medium-holder. The medium-holder may then in a further, optional step be closed, preferably fluid-tight. That way, it can be prevented that the medium again absorbs humidity, while it is stored.

Advantageously, the holder of the medium can be freed of excess humidity. This may again allow better storage stability and delay an occurrence of the vinegar syndrome. Also, by keeping the medium in a fluid-tightly closed or enclosed medium-holder, spreading of an occurring vinegar syndrome can be prevented.

In some embodiments, during one step, further a pH-value and/or specific content of acetic acid of the medium is determined. If it is determined that a pH-value and/or a content of acetic acid is below a predetermined threshold value, a processing step of the medium with an acid-reducing and/or an acid-neutralizing medium can be conducted. That way, it can be achieved that the medium is stored with a vinegar-syndrome as little as possible, i.e., a content of free acetic acid being as low as possible. This can increase the storage stability.

The acid-neutralizing medium can be a natron base. The acid reducing medium can be water. In the following, it is always referred to an acid reducing medium, wherein this means a dilution, for instance with water, as well as neutralization, also partly, of the present acid, for instance with natron base.

Alternatively or in addition, an information can be output or be stored, for instance on an RFID-chip or another common data storage, wherein these information comprise the detected humidity value of the medium and/or the medium-holder and/or the pH-value and/or the detected content of acetic acid. These determined data can be stored in a storage of the control element. The data can also be transmitted through a network or through another, known connection to a computer, a server or to another storage medium. That way, the storage conditions can be surveyed and monitored for longer terms. Thus, changes can be recognized quickly and a degradation of storage conditions can be omitted or reduced.

In some embodiments an amount of acid reducing medium and/or a processing time with the acid reducing medium is determined based on the detected pH-value and/or the content of acetic acid, in order to set the pH-value and/or content of acetic acid of the medium to a predetermined value.

In a preferred embodiment, the neutralization is affected by means of an aqueous solution of natron base. In some embodiments, prior to beginning the processing, the pH-value is measured and the processing time and/or the pH-value of the natron base are determined required for neutralizing the acetic acid. In some alternative embodiments of the invention the pH-value is measured or observed on a regular or irregular basis during the period of processing in random samples. That way, during processing the processing time can be adapted to the actual conditions. That way, an improved neutralization of the acetic acid can be conducted. The pH-value of the medium can specifically be set to a desired, in particular to a neutral, value. This can increase the storage conditions of the medium.

Subsequent to the processing with natron base, the medium and/or the medium-holder can be rinsed with a solvent and/or with water, in particular with distilled water. That way, remains of the natron base can be removed.

Besides, in an analogous way the surveillance of humidity can be conducted in regular or irregular intervals.

Advantageously, the step for treating the medium with the acid reducing medium is carried out prior to the step of applying the heat power. That way, the step for withdrawing the humidity in the medium can at the same time serve for withdrawing the water applied for cleaning or neutralizing. This can reduce the processing time, since a step for treating with a dielectric heating means for dehumidifying or drying has to be conducted only once.

In further alternative embodiments merely water, in particular distilled water, is applied to the medium in order to reduce the pH-value.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

Further advantages, advanced developments, and details arise from the following explanations with reference to the figures. It is to be understood that the presentations in the figures are merely examples for possible embodiments, without desiring to reduce the invention to these specific embodiments. Therein show:

### BRIEF DESCRIPTION OF THE FIGURES OF THE DRAWINGS

FIG. 1 a drawing of a processing device according to an embodiment of the invention.

FIG. 2 a drawing of a processing device according to another embodiment of the invention.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

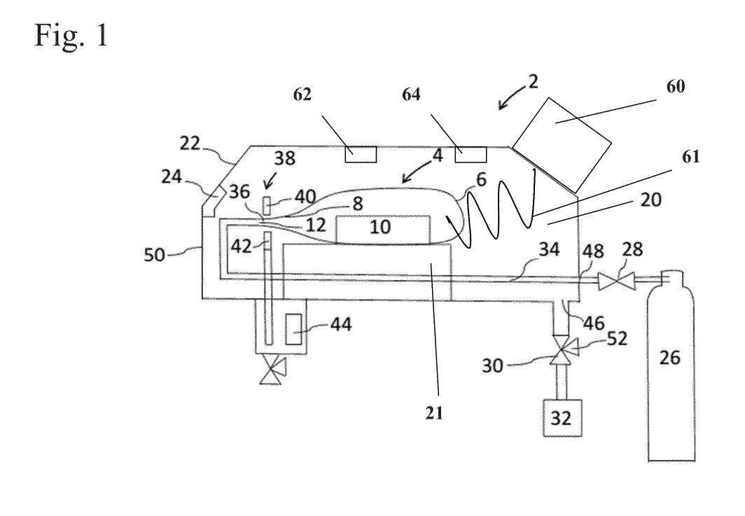

In FIG. 1, a medium-holder, here embodied as a media container 4 is shown, which is arranged in a processing device 2. The expressions media container 4 and processing device 2 are to be understood such that therewith also only a medium 10, for instance a film roll or a film, can be protected. At present, media container denotes a specific embodiment of a medium-holder.

The medium 10 is situated in the media container 4. The medium 10 can be placed in a bag 6 in the media container 4 through opening 12. The media container 4 comprises a closure 8, which closes the media container in a fluid tight way, as soon as it is closed.

The processing device 2 comprises a cover 22, which is attached to a base body 50 at a hinge 24. The cover 22 and the base body 50 form a chamber, in which the media container 4 is situated. For this, the media container 4 or the medium 10 are placed on a support 21 in the processing device 2.

As soon as the media container 4 is placed in the chamber 20 and the cover 22 is closed, the valve 30 is opened and the chamber 20 and the inside of the bag 6 is evacuated, in particular of oxygen, by means of a pump 32 and an evacuation opening 46. For this, the closing device 38 keeps the bag open by means of a first closing element 40 and a second closing element 42, such that the closure 8 forms an opening 12, through which gas can flow from the bag or from the media container 4.

As soon as the bag is sufficiently filled with cover gas up to a predetermined pressure, the first closing element 40 and the second closing element 42 are closed by the means of the closing control device 44 and are heated by means of a heating device in the range of the closure 8, such that the closure 8 is closed. The closure 8 may, on its inside, comprise a sealing membrane. The first closing element 40 may form a sealing bar and the second closing element 42 can form a counter pressure bar. In the sealing bar 40 and in the counter pressure bar 42, a sealing wire can be arranged, which is heated by electric current or an electric impulse. The inside of the bag, which are capable to be hot sealed, thus fuse.

Afterwards, the first closing element 40 and the second closing element 42 can be closed partially by means of the closing control device 44, such that the medium is separated from the atmosphere in a fluid-tight way.

Prior to this, a cover gas can flow from the gas bottle 26 by way of a valve 28, a cover gas opening 48, and a cover gas pipe 34 and cover gas connection 36 into the bag 6.

As soon as the bag 6 is closed at the closure 8, a potentially remaining cover gas, in particular nitrogen, can be released from the chamber 20 by opening a valve 52.

As it is not shown in FIG. 1, in addition to or instead of the gas bottle 26 with the cover gas, a reservoir with distilled water and/or with acid-reducing medium, in particular natron base, may be provided. These two fluids, water or natron base, may be introduced into the media container 4 in the same way as described above regarding the cover gas. It is also possible that the medium 10 for this is not situated within the media container 4.

It is also possible that the application with fluid for acid reduction is performed by means of another device. For this, for instance a nozzle integrated into the device, which is connected to the fluid reservoir, guides the fluid to the material to be processed.

In the processing device 2 according to the embodiment shown in FIG. 1, further at an upper side of the inside, a sensor 62 is provided, which is built to detect a humidity value of the medium 10 and/or the medium-holder. Further, another sensor 64 is provided in the interior of the processing device 2, which is built to detect a pH-value, in particular of the medium 10. Both sensors may comprise a sensor head, which for instance can be brought into contact with the medium 10 or the medium-holder (not shown). That way, an improved spatial determination of the areas to be processed can be achieved. In the device of the embodiment according to FIG. 1, in a back region of the processing device 2, a microwave emitter 60 is provided as heating element or as heating source.

The microwave emitter 60 is built such and arranged such, that emitted microwaves 61, symbolized in the figures by the wave shaped line, are emitted in the direction of the support 21, such that the medium 10 and/or the medium-holder can be reached or penetrated by the microwaves 61.

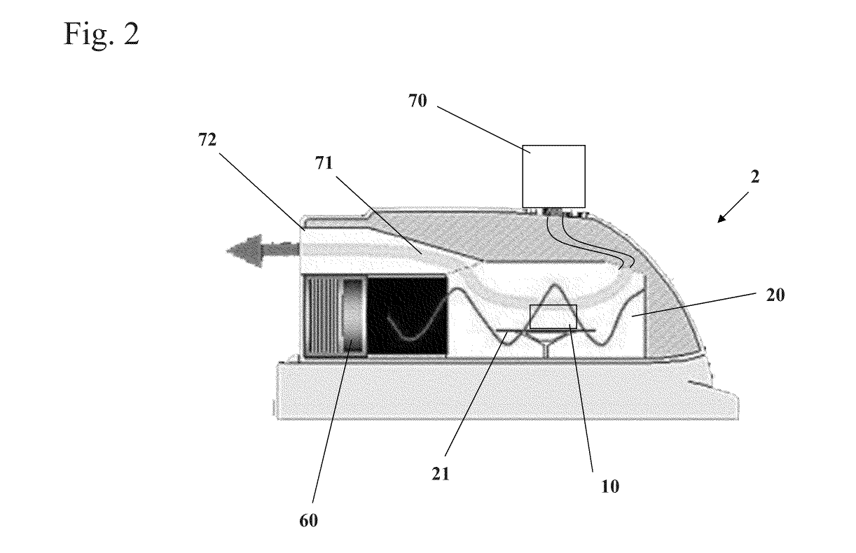

FIG. 2 shows a further embodiment of the present invention, wherein the same reference signs denote the same or similar members. Therefore, a repeated description is not provided.

In the processing device 2 according to FIG. 2, a fan 70 is provided. The fan 70 is arranged and built such that it creates an airflow 71, which takes course through the chamber 20. At an exit window 72, the airflow 71 leaves the chamber 20. The airflow 71 therein is guided in the chamber 20 past the medium 10 or the medium-holder on the support 21. The airflow may be created prior to, during, and/or after the microwave emitter 60 emits the microwave radiation 61. That way, the humidity leaving the medium 10 or the medium-holder can be absorbed and transported away by the airflow 71. The airflow can also be set such that a drying of the surface of the medium 10 or the medium-holder is caused directly by the airflow, by blowing-off the surface.

In the fan 70 or in the proximity of the airflow 71, a heating device (here not shown) may further be provided, which may heat the airflow. Thus, a bigger amount of humidity can be transported away with the heated airflow.

In the embodiment shown in FIG. 2 it was resigned from showing the sensors and further components, in order to allow for better clarity. The absence of these components in FIG. 2 may not allow the conclusion of their absence in the embodiment.

The present invention may be a complete storage device, with which a medium 10, in particular a film roll, may at first be processed and afterwards immediately be packed for archiving. This processing can, according to the invention, be the dehumidification of the medium by means of dielectric radiation influence, here microwaves. Alternatively or in addition, the processing may also be a pH-value reduction by reducing or neutralizing the acid content, in particular the content of acetic acid.

Within the scope of the invention, however, also a processing device is suggested, which is built such that it carries out only a dehumidification, an acid reduction or both, without having to carry out immediate storage.

It is noted, that in the above explained description, a dehumidification of the medium 10 is conducted at a time, when it is possible to transport away the humidity. In particular, no dehumidification is performed within the inside of a media container, which is already closed in a fluid-tight way.

Conclusively, the invention relates to a device 2 for processing a medium 10, in particular for long-term storage and/or archiving of the medium. The device comprises a sensor 62 for detecting a humidity value of the medium 10 and/or of a medium-holder 4, a heat source of the type of the heating element 60, in order to dielectrically heat the medium 10 and/or the medium-holder 4, and a control element, which is built such that it determines, based on the detected humidity value, a heating power to be applied to the medium 10 and/or the medium-holder 4 in order to set the humidity of the medium 10 to a predetermined value. Further, the invention concerns a method for the corresponding processing of the medium 10 or the medium-holder 4.

This allows treating of media on the basis of cellulose acetate with a specific liquid for neutralization of acetic acid and reducing the humidity, which is present in or on a medium, for instance in or on the components of the carrier medium such as film, paper, leather and/or fabric, or the materials or substances of the information carrier layer.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A device for processing a medium, with:
a sensor for detecting a humidity value of the medium and/or a medium-holder,
a heating element in order to dielectrically heat the medium and/or the medium-holder, and
a control element, built to determine, based on the detected humidity value, a heating power, which is to be applied to the medium and/or the medium-holder, in order to set the humidity of the medium to a predetermined value.

2. The device for processing a medium according to claim 1, wherein the heating element comprises a microwave emitter.

3. The device for processing a medium according to claim 1, wherein the device comprises a sensor, which is built to detect a pH-value and/or an acetic acid content of the medium and/or the medium-holder.

4. The device for processing a medium according to claim 1, wherein the control element comprises a storage, which is built to store the detected humidity value and/or the detected pH-value and/or the acetic acid content.

5. The device for processing a medium according to claim 1, wherein the device comprises means for neutralization of acid.

6. The device for processing a medium according to claim 5, wherein the means for neutralizing acid is built such that it may receive an alkaline solution, in particular a natron-water base, and apply it on and/or in the medium.

7. The device for processing a medium according to claim 1, wherein the device further comprises a fan, which is built to generate an air movement across the medium.

8. The device for processing a medium according to claim 1, wherein the medium is an audio-, film-, and/or video-medium, in particular a film roll.

9. A method for processing a medium, comprising the steps of:
detecting the humidity of the medium with a sensor,
determining the heat power to be applied, which is required in order to set the humidity of the medium to a predetermined value,
emitting the heating power thus determined by means of a heat emitter to the medium.

10. A method according to claim 9, further comprising the steps of:
detecting a pH-value and/or an acetic acid content of the medium and, in case it is detected that a pH-value and/or an acetic acid content is below a predetermined threshold value,
treating the medium with an acid reducing medium.

11. The method according to claim 9, wherein the detected humidity value and/or the detected pH-value and/or acetic acid content is stored in a storage of a control element.

12. The method according to claim 10, wherein based on the determined pH-value and/or acetic acid content, an amount of acid reducing medium and/or an application time with the acid reducing medium is determined, in order to set the pH-value and/or acetic acid content of the medium to a predetermined value.

13. The method according to claim 9, wherein the detection of the humidity of the medium and/or the medium-holder during the application of heat power and/or the detection of the pH-value and/or the acetic acid content of the medium during the process of acid reduction is repeatedly, in particular regularly, conducted.

14. The method according to claim 11, wherein the step to treat the medium with the acid reducing medium is conducted prior to the step of applying the heat power.
